(19) United States
(12) Patent Application Publication
(10) Pub. No.: US 2011/0145846 A1
(43) Pub. Date: Jun. 16, 2011

(54) SYSTEM AND METHOD FOR PROVIDING PERSONAL BROADCASTING HOME SHOPPING SERVICE USING MOBILE IPTV SERVICE

(75) Inventor: Sung Hee KIM, Daejeon (KR)

(73) Assignee: Electronics and Telecommunications Research Institute, Daejeon (KR)

(21) Appl. No.: 12/857,999

(22) Filed: Aug. 17, 2010

(30) Foreign Application Priority Data
Dec. 10, 2009 (KR) 10-2009-0122686
Mar. 9, 2010 (KR) 10-2010-0020963

(51) Int. Cl. H04N 7/16; H04N 7/173

(52) U.S. Cl. 725/5; 725/97; 725/62

(57) ABSTRACT

A personal broadcasting home shopping providing system is linked with a seller terminal capable of photographing a moving picture and one or more viewer terminals capable of receiving a broadcasting signal, which each is provided with a communication function. At this time, the service control server establishes a personal broadcasting home shopping channel in accordance with a request from the seller terminal and sets a reception target of the personal broadcasting home shopping channel. A relay server receives a real-time moving picture of a sold product photographed by the seller terminal from the seller terminal through a mobile communication network and transmits the received real-time moving picture to one or more viewer terminals included in reception target information set by the service control server.

### CROSS-REFERENCE TO RELATED APPLICATION

This application claims priority to and the benefit of Korean Patent Application Nos. 10-2009-0122686 and 10-2010-0020963 filed in the Korean Intellectual Property Office on Dec. 10, 2009 and Mar. 9, 2010, the entire contents of which are incorporated herein by reference.

### BACKGROUND OF THE INVENTION

(a) Field of the Invention

The present invention relates to a system and a method for providing a home shopping service using a mobile IPTV service.

(b) Description of the Related Art

Since a known wire IPTV service using apparatuses such as a cable TV, an Internet TV such as a web TV, a TV (TeleVision) provides a service through a fixed terminal, the known wire IPTV service has a spatial limit in receiving the service. A mobile IPTV (Internet protocol TV) can overcome such a spatial limit.

Further, in the case of the known IPTV service, the service is defined and produced by a service provider and general users can use the corresponding service without a temporal limit. However, the general users cannot watch broadcast contents which are not produced in a program by the service provider.

Contrary to this, in the mobile IPTV field, a personal broadcasting service in which the general users can provide broadcasting services is provided regardless of a location and a time by taking advantage of mobility of a terminal as an application service, thus, value creation is expected.

However, up to now, the personal broadcasting service cannot be implemented as a realistic service due to a short in a service scenario and an incomplete implementation technology.

Although the known wired IPTV service has an advantage of interactive communication, methods of a limited format in which a contents provider communicates with a receiver by just using a text are being proposed. This may be a limit to apply the known wired IPTV service to a service for creating a new additional value.

Further, a home shopping service using the known wired IPTV service allows customers to buy and sell products through phone consulting or a credit card and a debit form while watching good contents broadcasted through a TV medium (cable TV) in a home or an office.

However, such a service provides a live shopping and a reservation shopping, but when the customers have any questions while watching a broadcast, this service cannot be asked a question and give an answer on-line. Further, there is no procedure or method in which model's demonstration or close-up photographing can be requested through chatting.

In addition, in the wired IPTV service, since service contents are provided to all users in a broadcast form, a service form for a limited target such as a predetermined group or community is not implemented.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and a method for providing a personal broadcasting home shopping service using a mobile IPTV service in which individuals implement a home shopping service primarily for a group/community on the basis of a 3G more mobile communication network providing a multimedia broadcast multicast service (MBMS) while providing a broadcasting service for a real-time e-commerce service between a producer and a consumer on the basis of a mobile IPTV.

An exemplary embodiment of the present invention provides a system for providing a personal broadcasting home shopping service. The system for providing a personal broadcasting home shopping service in interworking with a seller terminal capable of photographing a moving picture and at least one viewer terminal capable of receiving a broadcasting signal, which each is provided with a communication function that includes: a service control server that establishes a personal broadcasting home shopping service in accordance with a request from the seller terminal and provides an advertisement for the personal broadcasting home shopping service to unspecified ordinary people or a designated user group in order to recruit viewers of the personal broadcasting home shopping service; and a service center that establishes a broadcast/multicast service session with at least one viewer terminal by receiving information on the personal broadcasting home shopping service of the seller personal from the service control server, receives a real-time moving picture of a product from the seller terminal, and multicasts the received real-time moving picture to the at least viewer terminal through the broadcast/multicast service session.

Another embodiment of the present invention provides a method for providing a personal broadcasting home shopping service by a personal broadcasting home shopping service providing system that interworks with a seller terminal capable of photographing a moving picture and at least one viewer terminal capable of receiving a broadcasting signal, which each is provided with a communication function, comprising:

establishing a personal broadcasting home shopping channel in accordance with a request from the seller terminal and setting reception target information of the personal broadcasting home shopping channel; receiving a real-time moving picture of a product from the seller terminal through a mobile communication network; and multicasting the real-time moving picture of the product to at least one viewer terminal through an broadcast/multicast service session established to the at least one viewer terminal included in the reception target information.

### BRIEF DESCRIPTION OF THE DRAWINGS

FIG. 1 is a configuration diagram of a system for providing a personal broadcasting home shopping service using a mobile IPTV service according to an exemplary embodiment of the present invention;

FIG. 2 is a block diagram showing a detailed configuration of a relay server according to an exemplary embodiment of the present invention;

FIG. 3 is a block diagram showing a detailed configuration of a service control server according to an exemplary embodiment of the present invention;

FIGS. 4A and 4B are a flowchart showing a method for providing a personal broadcasting home shopping service using a mobile IPTV according to an exemplary embodiment of the present invention;

FIG. 5 is a flowchart showing an advertisement file generation method according to an exemplary embodiment of the present invention; and

FIG. 6 is a flowchart showing a method for setting information to be received according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, unless explicitly described to the contrary, the word “comprise” and variations such as “comprises” or “comprising”, will be understood to imply the inclusion of stated elements but not the exclusion of any other elements.

In this specification, a mobile Internet protocol TV (IPTV) service is defined as a service providing a known IPTV service providing an information service, moving picture contents, and a broadcast through a television set to a mobile terminal by using high-speed Internet. Herein, if even the television set receiving the known IPTV service has a function to request and receive desired information through interactive communication, the television set is included in the mobile IPTV service.

Further, although a personal broadcasting home shopping service is similar as the known home shopping service, the personal broadcasting home shopping service is defined as a personal participation type home shopping service in which the home shopping service is not unilaterally provided by a broadcasting station but individuals may serve as a home shopping service provider.

Hereinafter, a system and a method for providing a personal broadcasting home shopping service using a mobile IPTV service according to an exemplary embodiment of the present invention will be described with reference to the accompanying drawings.

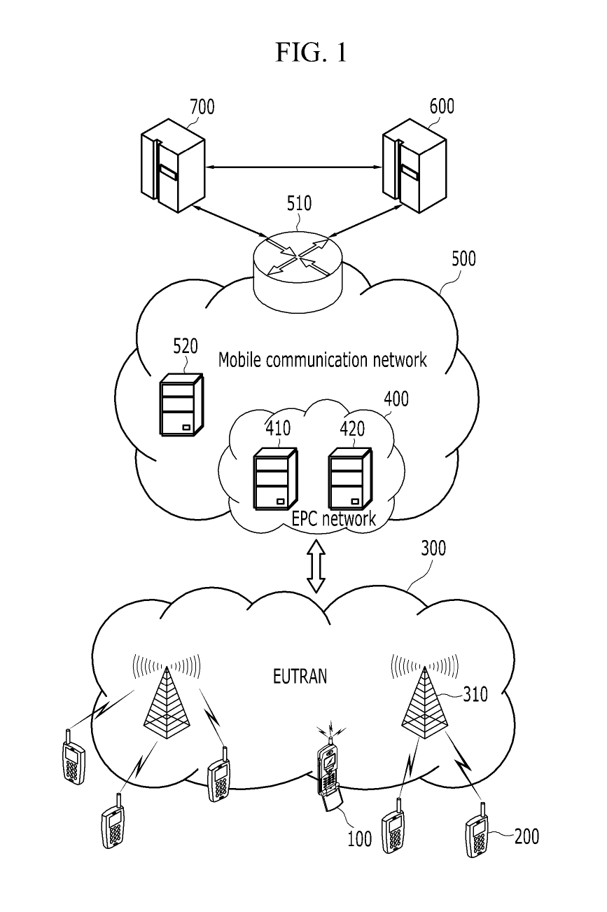

First, FIG. 1 is a configuration diagram of a system for providing a personal broadcasting home shopping service using a mobile IPTV service according to an exemplary embodiment of the present invention.

Referring to FIG. 1, the personal broadcasting home shopping service providing system includes a seller terminal 100, at least one viewer terminal 200, an evolved universal mobile telecommunications network terrestrial radio access network (EUTRAN) 300, an evolved packet core (EPC) network 400, a mobile communication network 500, an evolved broadcast multicast service center (eBM-SC) 600, and a service control server 700. These components will be described below.

The seller terminal 100 and at lease one viewer terminal 200 are user equipment (UE) that can transmit and receive a broadcasting multimedia contents packet.

At this time, the seller terminal 100 represents terminals of a producer, a seller, and a dealer of products who sell the products through the personal broadcasting home shopping service. A seller who desires providing the personal broadcasting home shopping service designs the service by negotiating with a producer or a dealer of a predetermined product which the seller desires selling. For example, the seller designs the service by collecting all information required for selling including a selling date, a type and a price of a sold product, a selling method, etc.

In addition, the seller establishes the personal broadcasting home shopping service to interactively communicate with the service control server 700 by using the seller terminal 10 based on the information designed as above. At this time, the seller terminal 100 is based on a subscriber terminal of the mobile communication network 500, but includes a communication network provider providing the mobile IPTV service.

The seller introduces the product and performs a selling action through models' demonstration or various communications with the product and the producer on behalf of purchasers. Such a selling action is photographed by using the seller terminal 100 and the photographed moving picture is transmitted to the at least one viewer terminal 200 in a streaming form, that is, in a multicasting form.

At this time, the seller terminal 100 may designate a service receiver group that receive his/her personal broadcasting home shopping service. Designation of the receiver group may be a list of predetermined users or a predetermined condition and may target unspecified individuals.

Further, at least one viewer terminal 200 views the personal broadcasting home shopping service provided by the seller terminal 100. The terminals 200 receives the personal broadcasting home shopping service in a multicasting form. The viewer terminal 200 may be unspecified majority of terminals, but they may belong to a predetermined target that conforms to a condition designated by the seller terminal 100 or a group that has a community relationship with the seller terminal 100.

In the case in which the viewer terminal 200 has any question while the personal broadcasting home shopping service provided by the seller terminal 100 is reproduced, the viewer terminal 200 makes inquiries, get an answer or acquire additional product information through multi-user communication. Matters inquired through the multi-user communication become information which can be acquired by all viewer terminals 200 that participate in the multi-user communication with the seller terminal 100. Besides, the individuals may mutually acquire new information by questions of other individuals.

When the view terminal 200 determines purchasing of the corresponding product, the terminal 200 transmits information (i.e., information for receiving the product) on a purchaser. As a transmission method, various methods registered in the service control server 700 are utilizable and for example, a short message service (SMS) may be used and an E-mail, etc. may be used.

Further, the viewer terminal 200 performs payment of the purchase-determined product. Various methods registered in the service control server 700 may also be applied. For example, the viewer terminal 200 hints only a purchasing intention during the personal broadcasting home shopping service and afterwards, may make additional payment.

At this time, when the purchasing and payment processes for the corresponding product are terminated, the viewer terminal 200 may terminate the service without using the personal broadcasting home shopping service any longer even while the mobile IPTV service is in progress.

Meanwhile, a network configuration that enables the seller terminal 100 and at least one viewer terminal 200 to provide and receive the personal broadcasting home shopping service to and from each other will be described.

The EUTRAN 300 includes a plurality of eNodeB (or a base station device) 310 that takes charge of managing wireless resources and setting up wireless channels for wireless transmission. The eNodeB 310 receives uplink signals transmitted from the user terminals 100 and 200 and transmits downlink signals to the user terminals 100 and 200 at a physical layer level. That is, the eNodeB 310 transmits and receives signals to and from the user terminals 100 and 200 and serves as an access point of the user terminals 100 and 200. At this time, the eNodeB 310 manages cell-unit wireless resources to communicate with the user terminals 100 and 200 that exist in the corresponding cell through the wireless channels.

The EPC network 400 takes charge of controlling an evolved multimedia broadcast multicast service (EMBMS) session and transmitting and receiving traffics to and from an external network in link with the EUTRAN 300. The EPC network 400 sets up an MBMS bearer for the EMBMS in link with the eNodeB 310 of the EUTRAN 300 and transmits contents through the set-up MBMS bearer. The EPC network 400 includes a multimedia broadcast multicast server (MBMS) 1 410 and an MBMS 2 420. The MBMS 1 410 controls a session of the mobile communication network 500 in order to support the EMBMS service. The MBMS2 420 manages an MBMS traffic path together with the MBMS 1 410, transfers an MBMS traffic through the set path, and takes charge of an MBMS gateway function.

The mobile communication network 500 includes a wibro/mobile WiMAX capable of providing a broadcast service or a multicast broadcast service, etc., in addition to a 3GPP mobile communication network. At this time, the mobile communication network 500 includes a gateway 510 and a relay server 520.

Herein, the gateway 510 provides paths to enable the components 410 and 420 of the EPC network 400, the relay server 520, the eBM-SC 600, and the service control server 700 as well as network components (not shown) of the mobile communication network 500 to transmit and receive data therebetween.

The relay server 520 takes charge of a routing function to transmit real-time moving picture traffics received from the seller terminal 100 through the mobile communication network to the eBM-SC 600. For this, the relay server 520 receives set-up information of the personal broadcasting home shopping service established by the seller terminal 100 from the eBM-SC 600. In addition, the relay server 520 receives the real-time moving picture traffics of product selling photographed through a camera incorporated in or an external camera connected to the seller terminal 100 from the seller terminal 100 and transmits the received traffics to the eBM-SC 600. At this time, the relay server 520 may operate an additional buffer for relaying the real-time moving picture traffics.

The relay server 520 may be implemented by integrating with the MBMS 2 420 serving as a gateway for the real-time moving picture traffics in order to perform a mobile communication network based broadcast/multicast service.

Meanwhile, when a transmission medium used to receive the real-time moving picture traffics from the seller terminal 100 is not the mobile communication network but an additional communication network, the relay server 520 acquires service information on the personal broadcasting home shopping service established in link with the service control server 700. In addition, the real-time moving picture traffics received from the seller terminal 100 may be transferred to the eBM-SC 600 in the form of a contents provider.

Further, the eBM-SC 600 is a node that takes charge of controlling the EMBMS service and exists as one functional component in order to provide the EMBMS service. The eBM-SC 600 serving as a principal agent for management and control of the EMBMS service controls an MBMS session start procedure or an MBMS session stop procedure in order to manage starting and stopping all broadcast or multicast type EMBMS services.

The eBM-SC 600 controls the MBMS session for the personal broadcasting home shopping service and controls a multicasting transmission operation of the EPC network 400 in link with the relay server 520 and the service control server 700.

The eBM-SC 600 sets up the multicast bearer for broadcasting in accordance with the MBMS session start procedure when it is the start time of the personal broadcasting home shopping service and requests the relay server 520 to transmit contents traffics uploaded from the seller terminal 100 to the eBM-SC 600 when a preparation for packet transmission is completed.

At this time, in a structure without the relay server 520, the eBM-SC 600 itself receives the traffics transmitted from the seller terminal 100 and transfers the received traffics through the previously generated multicast bearer.

At this time, the eNodeB 310 sets up an EMBMS bearer to which the contents will be actually transferred and the bearers are allocated to use resources on the basis of a bearer transmission capacity and QoS information depending on characteristics of the contents.

Further, in the case of the multicast service, a multicast join is received from the user terminal 100 and 200 to configure a multicast tree that will transfer data which the corresponding service wants to transfer to the user terminals 100 and 200. Such a configuration is performed through an MBMS activation procedure. At this time, a service authority verification step of verifying whether or not a terminal requesting the multicast join is an authorized user who can use the personal broadcasting home shopping service is performed. The service authority verification step is performed using service authority information configured based on a list of viewers, which is received from the service control server 700. When it is determined that the multicast join of the user is an authorized user who can use the service, lower nodes that exist on the traffic transmission path are registered to allow a path extending to the user terminals 100 and 200 through upper nodes to pass through the lower node themselve. Each of the MBMS 1 410, the MBMS 420, the eNodeB 310, and the user terminals 100 and 200 in addition to the eBM-SC 600 generates a context for the corresponding EMBMS service. Contents are transferred to all users or user terminals 100 and 200 of a predetermined group which are positioned in a service area in link with the UTRAN that controls and manages the broadcast/multicast bearer.

The service control server 700 provides a home shopping service environment primarily for a group or community that targets unspecified individuals or a predetermined group by establishing the personal broadcasting home shopping service capable of providing interactive communication by using the mobile IPTV service in link with the eBM-SC 600.

As described above, the EUTRAN 300, the EPC network 400, the mobile communication network 500, the relay server 520, the eBM-SC 600, and the service control server 700 transfer multimedia contents to at least one viewer terminal 200 at a designated time by one-time transmission by establishing and managing a session and a bearer for transferring the contents received from the seller terminal 100. That is, the seller terminal 100 accesses the service control server 700 to establish the personal broadcasting home shopping service channel, and photographs and transmits a moving picture of a product to be sold. Therefore, the relay server 520 receives moving picture data and transfers it to the eBM-SC 600. Thereafter, the eBM-SC 600 transfers the moving picture data to at least one viewer terminal 200 through the EPC network 400 in the multicasting method.

As such, when the personal broadcasting home shopping service using the mobile IPTV service is provided, products are sold in real time. Therefore, a selling service is available in a wholesale/auction site which is maintained for a short time or frequently formed or closed or an area having bad positional accessibility such as a specialty district. Further, group buying or a specialized premium service targeting a predetermined community is available by managing a group of purchasers who will participate in the selling action.

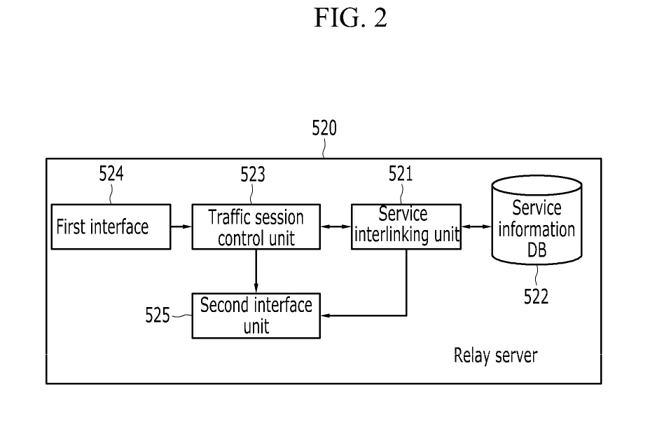

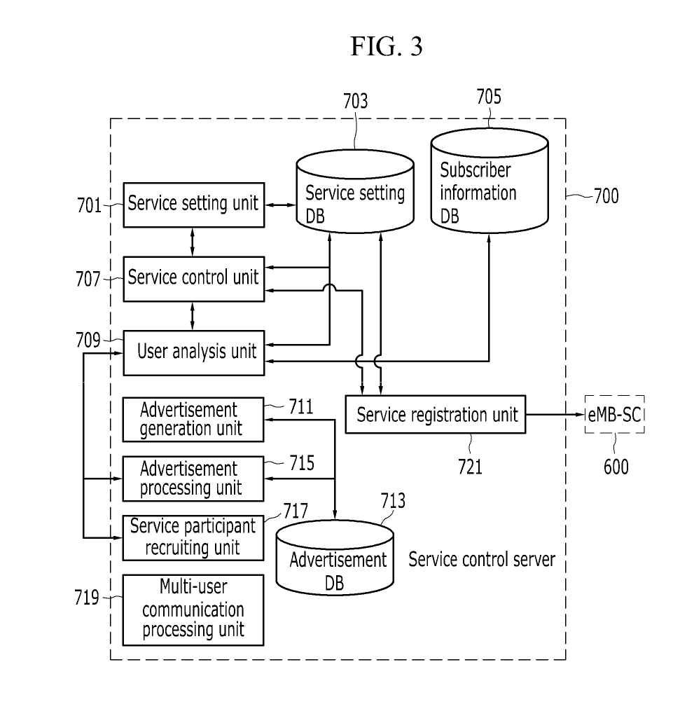

At this time, detailed configurations of the relay server 520 and the service control server 700 will be described with reference to FIGS. 2 and 3.

FIG. 2 is a block diagram showing a detailed configuration of a relay server according to an exemplary embodiment of the present invention.

Referring to FIG. 2, the relay server 520 includes a service interlinking unit 521 a service information DB 522, a traffic session control unit 523, a first interface unit 524, and a second interface unit 525.

The service interlinking unit 521 receives service set-up information set up by the seller terminal 100 from the eBM-SC 600 before the seller terminal 100 starts the service. Herein, the service set-up information includes information such as a service identifier, an IP multicast address, a service start time and a service stop time that are required to receive traffics to be uploaded from the seller terminal 100. The traffic session control unit 523 receives real-time moving picture data from the seller terminal 100. At this time, the traffic session control unit 523 includes a large buffer and stores the received real-time moving picture traffic in the large buffer for a predetermined time in accordance with the transmission method of the personal broadcasting home shopping service. In addition, a delay transmission method to transfer the real-time moving picture traffic according to a request from the eBM-SC 600 may be used. Further, a real-time transmission method to transfer the real-time moving picture traffic received from the seller terminal 100 to the eBM-SC 600 may be supported.

The traffic session control unit 523 establishes two EMBMS traffic sessions. At this time, two traffic sessions as sessions for receiving the real-time moving picture traffic received from the seller terminal 100 includes a first traffic session uploading the real-time moving picture traffic transmitted from the seller terminal 100 and a second traffic session transferring the real-time moving picture traffic to be multicasted to the viewer terminal 200 to the eBM-SC 600. Herein, the real-time moving picture traffic received from the seller terminal 100 through the first traffic session may be a unicast traffic or a multicast traffic. At this time, when the real-time moving picture traffic received from the seller terminal 100 is the unicast traffic, the traffic session control unit 523 converts the unicast traffic to the multicast traffic.

The first interface unit 524 receives the real-time moving picture data from the seller terminal 100 through the EUTRAN 300 and the seller terminal 100 through the established bearer.

The second interface unit 525 transmits the real-time moving picture traffic received from the seller terminal 100 to the viewer terminal 200 at the time of being requested to transmit the real-time moving picture traffic from the eBM-SC 600. At this time, when the real-time moving picture traffic received from the seller terminal 100 is the unicast traffic, the traffic session control unit 523 converts the unicast traffic to the multicast traffic and transmits the corresponding traffic.

FIG. 3 is a block diagram showing a detailed configuration of a service control server according to an exemplary embodiment of the present invention.

Referring to FIG. 3, the service control server 700 includes a service setting unit 701, s service setting DB 703, a subscriber information DB 705, a service control unit 707, a user analysis unit 709, an advertisement generation unit 711, an advertisement DB 713, an advertisement processing unit 715, a service participant recruiting unit 717, a multi-user communication processing unit 719, and a service registration unit 721.

The service setting unit 701 provides a user interface environment for receiving the service set-up information in order to establish the personal broadcasting home shopping service. At this time, the service setting unit 701 may be implemented in the form of a server providing a wire/wireless Internet website (or exclusive web page).

The service setting unit 701 receives the service set-up information from the seller terminal 100. The service set-up information may include information on a reception target of a personal broadcasting home shopping broadcast when the established personal broadcasting home shopping service targets the already configured viewer group as well as information relating to selling including information on sold products and information on the seller. For example, the reception target information may be a receiver group list constituted by at least one viewer terminal 200 which have the community relationship with the seller terminal 100.

At this time, the service information includes information on the service provider in addition to the information on the service. The service provider information may be utilized for the product purchasers to verify the reliability of the corresponding selling action or directly communicate with the seller before, in the middle of, and after shopping. In particular, the service provider information necessarily includes a phone number of the service provider.

When setting the service of the seller terminal 100 is completed, the service setting unit 701 stores the service set-up information in the service setting DB 703, and requests the advertisement generation unit 711 to produce advertisement contents for the service.

The service setting DB 703 stores the service set-up information and the reception target information of the seller terminal 100.

Herein, the reception target information includes unspecified individuals in accordance with an operation rule of the service control server 700 itself or a community or a predetermined condition of the seller terminal 100. For example, the reception target information may be the receiver group list constituted by at least one viewer terminal 200 which have the community relationship with the seller terminal 100.

The service setting DB 703 stores the service set-up information and the reception target information of the seller terminal 100.

The subscriber information DB 705 stores subscriber information of the personal broadcasting home shopping service and includes information on subscribers of the seller terminal 100 and information on subscribers of at least one viewer terminal 200. That is, the subscriber information DB 705 stores information on subscribers which join in the personal broadcasting home shopping service in order to provide and receive the personal broadcasting home shopping service and includes information on a sex, an age, an occupation, a hobby, an address, etc. of each of the subscribers.

The service control unit 707 manages a broadcasting schedule of the personal broadcasting home shopping service registered in the service setting DB 703 and executes a series of processes related to purchasing determination, and payment and delivery procedures according to requests from at least one viewer terminal 200. The procedures of the known Internet shopping mall and IPTV home shopping may be used as the processes and various embodiments of the procedures may be applied.

The service control unit 707 receives an SMS or an E-mail including purchasing determination, a payment request, and a delivery request from at least one viewer terminal 200.

The service control unit 707 may use a group message service in order to provide information for payment to at least one viewer terminal 200.

The user analysis unit 709 designates an advertisement providing target for the established personal broadcasting home shopping service. In addition, when service viewers are selected by an advertisement, the selected viewers are stored in the corresponding service receiver list of the service setting DB.

When the seller requesting establishment of the personal broadcasting home shopping service does not separately designate the reception target information, the user analysis unit 709 selects unspecified individuals in accordance with the operation rule of the service control server 700 itself as an advertisement target for the corresponding service. Further, when the seller proposes predetermined conditions, i.e., married women more than the thirties, adolescents in the tens, or men more than the forties, a user who conforms to the predetermined conditions is selected as the advertisement target by using the subscriber information stored in the subscriber information DB 705. Further, when the seller requesting service establishment proposes an additional user list, only the corresponding users are selected as the advertisement target.

The advertisement generation unit 711 generates an advertisement file for the personal broadcasting home shopping service established by the seller terminal 100 and generation of the advertisement file may be excluded when an additional advertisement service is not desired as an option of the seller terminal 100.

The advertisement generation unit 711 generates the advertisement file including summary information on the personal broadcasting home shopping service and a product to be sold by the service and seller information, and stores the generated advertisement file in the advertisement DB 713 on the basis of the set-up information of the personal broadcasting home shopping service stored in the service setting DB 703 in accordance with the request from the seller terminal 100. The advertisement file may be an advertisement file including various multimedia information or may include simple information of a text or photograph form.

At this time, the service summary information includes the information on the service provider in addition to the information on the service. The service provider information may be utilized for the product purchasers to verify the reliability of the corresponding selling action or directly communicate with the seller before, in the middle of, and after shopping. In particular, the service provider information necessarily includes the phone number of the service provider.

The advertisement processing unit 715 recruits viewers for the corresponding service in accordance with a service advertisement target and an advertisement method determined by the user analysis unit 709 on the basis of the advertisement file stored in the advertisement DB 713. When the advertisement of the personal broadcasting home shopping service targets unspecified individuals, the advertisement may have broadcasting guide and advertisement forms like an Internet e-commerce portal and when users who participate in the corresponding service are recruited, they are transferred to the user analysis unit 709 to be designated as a service receiving group. The user analysis unit 709 stores the received service receiving group in the service setting DB. Meanwhile, when the advertisement targets the already designated user group, advertisement information for the corresponding broadcast may be, in advance, transmitted to the users who belong to the corresponding group through a text message or an e-mail. In this case, a receiver list for the corresponding service targets only customers designated by the seller. Further, when the advertisement has the broadcasting guide and advertisement forms using the broadcasting service of the mobile communication network, the advertisement is registered in the mobile communication network as an additional service to be provided to viewer terminals of unspecified individuals. In addition, when predetermined users request reception of the corresponding broadcast, the requests are received and set as a reception viewer group of the personal broadcasting home shopping service. For this, advertisement contents include a method or an access route for to the users to request watching the service. For example, various methods including a method of transferring designated information to the service control server 700 when a predetermined icon is clicked and a method of transferring intentions of the users through a text message and an additional communication form may be used.

The advertisement method of the advertisement processing unit 715 follows the operation of the service control server 700 itself and various embodiments may be applied.

The service participant recruiting unit 717 processes the user who request watching the corresponding service by referring to the advertisement for the corresponding service performed by the advertisement processing unit 715. Information on users which is included in the advertisement information provided by the advertisement processing unit 715 in various forms or providing an intention to watch the corresponding service through an additional service participation request procedure is received and transferred to the user analysis unit 709 to be stored in the service setting DB.

The multi-user communication-user processing unit 719 manages a multi-user communication session between the seller terminal 100 and at least one viewer terminal 200 apart from the EMBMS session of the traffic session control unit 523. At this time, the multi-user communication processing unit 719 is linked with the EUTRAN 300 to establish a multi-user voice communication session and a multi-user video communication session. The multi-user communication processing unit 719 acquires necessary service information, that is, a receiver group list or a multicast group target list which is multi-user communication list information from the service setting DB 703 for call set-up to support the EUTRAN 300 to set up a multi-user communication call. Further, terminals that participate in communication may be displayed on screens of the seller terminal 100 and the viewer terminals 200 that participate in communication.

The service registration unit 721 registers an advertisement service for recruiting viewers for the personal broadcasting home shopping service of which establishment is requested by the seller and the personal broadcasting home shopping service of which establishment is requested targeting mobile communication subscribers in the eBM-SC 600. Further, the advertisement service is registered before the personal broadcasting home shopping service required by the seller is started, such that the mobile communication subscribers watch the corresponding advertisement contents and request watching the service.

The service registration unit 721 acquires from the service setting DB 703 service information required to register the personal broadcasting home shopping service provided from the mobile communication network to register the personal broadcasting home shopping service in accordance with a designated format. At this time, the receiver list for the personal broadcasting home shopping service should also be provided in addition to the service information. However, when the service is provided to unspecified individuals without an additional advertisement, the receiver list information may be excluded.

The eBM-SC 600 accepts registration of the personal broadcasting home shopping service on-line in order to provide the personal broadcasting home shopping service to the mobile communication subscribers through the registration. Therefore, the broadcast/multicast service function is driven based on the function.

Hereinafter, on the basis of the above-mentioned configuration, a method for providing the personal broadcasting home shopping service using the mobile IPTV service will be described. At this time, the method is described in link with the components of FIGS. 1 to 3 and like reference numerals refer to like elements.

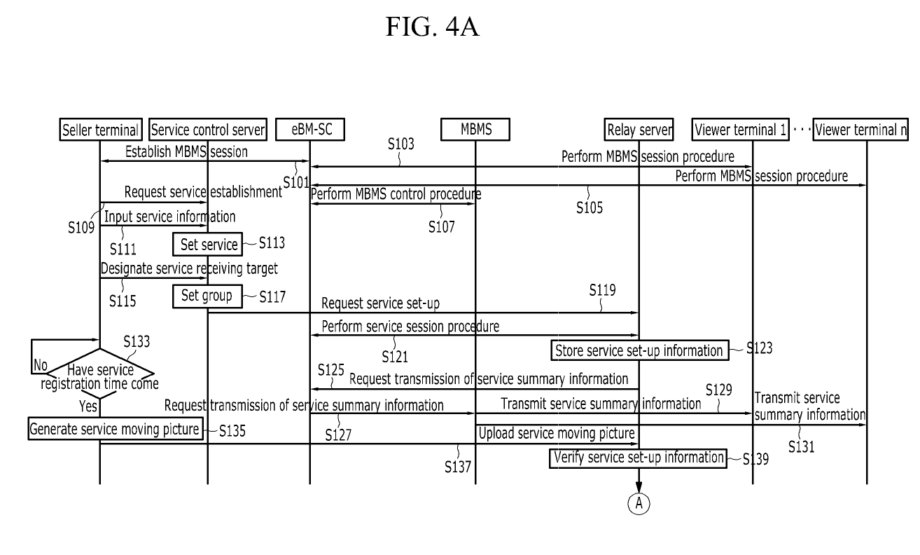

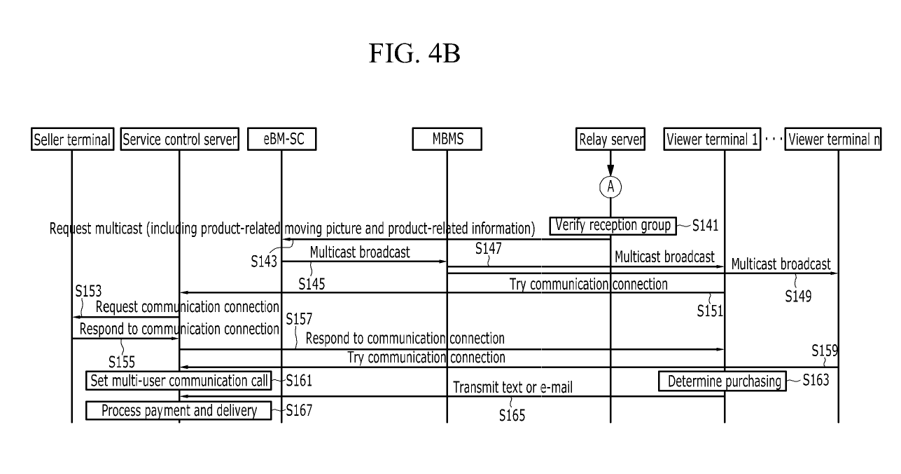

FIGS. 4A and 4B are a flowchart showing a method for providing a personal broadcasting home shopping service using a mobile IPTV service according to an exemplary embodiment of the present invention.

Referring to FIGS. 4A and 4B, a seller terminal 100 and at least one viewer terminal 1, . . . , n 200 performs an MBMS session procedure together with an eBM-SC 600 at the time of selecting power on or a data channel menu provided in a terminal (S101, S103, and S105). In this case, the eBM-SC 600 performs an MBMS control procedure together with MBMSs 410 and 420 of an EPC network 400 (S107).

Thereafter, the seller terminal 100 requests service establishment to a service control server 700 (S109) and inputs service information (S111). In this case, the service control server 700 sets up the service by establishing the personal broadcasting home shopping service on the basis of the information inputted at step S111 (S113). At this time, when the seller terminal 100 designates a service receiving target (S115), the service control server 700 sets a personal broadcasting home shopping service receiving group of the seller terminal 100 (S117).

In this case, the service control server 700 transmits set-up information of the established service and reception target information of the service while requesting service set-up to a relay server 520 (S119). The relay server 520 performs a service session procedure for operating in link with the eBM-SC 600 (S121). The service session procedure follows a prearranged rule and the MBMS session procedure may be performed.

The relay server 520 stores the service set-up information and the service receiving target information received at step S119 (S123). At this time, the service set-up information includes product-related text information.

The relay server 520 requests the eBM-SC 600 to transmit service summary information for the service established by the seller terminal 100 (S125). At this time, the service receiving target information received at step S119 is also transmitted in addition to the service summary information.

The eBM-SC 600 requests the MBMSs 410 and 420 of the EPC network 400 to transmit the service summary information to at least one viewer terminal 200 included in the reception target information (S127). In this case, the MBMSs 410 and 420 of the EPC network 400 multicast the service summary information to at least one viewer terminal 200 (S129 and S131).

Thereafter, the seller terminal 100 generates a service moving picture (S135) and uploads the generated service moving picture to the relay server 520 (S137) when a service registration time has come (S133). In this case, the relay server temporarily stores the uploaded service

In addition, the relay server verifies the stored service set-up information (S139) to extract product-related information. Further, the relay server verifies the reception target information (S141) in FIG. 4B.

The relay server 520 requests the eBM-SC 600 to multicast the temporarily stored service moving picture, that is, a product selling moving picture through a first traffic session and requests the eBM-SC 600 to multicast product-related information related to the product selling moving picture to be multicasted to the first traffic session through a second traffic session (S143). In this case, the eBM-SC 600 multicasts the product selling moving picture and the product-related information to at least one viewer terminal 200 included in the reception target information through the MBMSs 410 and 420 of the EPC network 400 (S145, S147, and S149). In this case, one or more viewer terminals 200 displays the product selling moving picture received through the first traffic session and the second traffic session, which includes the product-related information on a screen.

Thereafter, when the viewer terminal 1 200 first tries communication connection with a seller of a product selling moving picture which is being watched, a communication connection request is transmitted to the service control server 700 (S151)

At this time, a phone number of the seller may be acquired through a broadcasting screen which is being reproduced in real time or through the previously received service summary information.

In this case, the service control server 700 transmits the communication connection request to the seller terminal 100 through an UTRAN 300 (S153). When a communication connection response is received from the seller terminal 100 (S155), the received communication connection response is transmitted to the viewer terminal 1 200 (S157) and communication connection is made between the seller terminal 100 and the viewer terminal 1 200.

At this time, when the viewer terminal n 200 tries communication connection with the seller, the communication connection request is transmitted to the service control server 700 (S159) in the same manner as above and the service control server 700 sets up a multi-user communication call through the UTRAN 300 among the viewer terminal 1 200, the viewer terminal n 200, and the seller terminal 100 (S161).

Meanwhile, when the viewer terminal 1 200 determines purchasing the product which is being watched (S163), for example, when the viewer terminal 1 200 clicks a purchasing determination button, purchasing determination or a purchasing request is transmitted to the service control server 700 (S165). At this time, the purchasing determination or purchasing request may be transmitted through an SMS or an E-mail.

In this case, the service control server 700 executes payment and delivery processes of the product of which purchasing is determined or requested (S167).

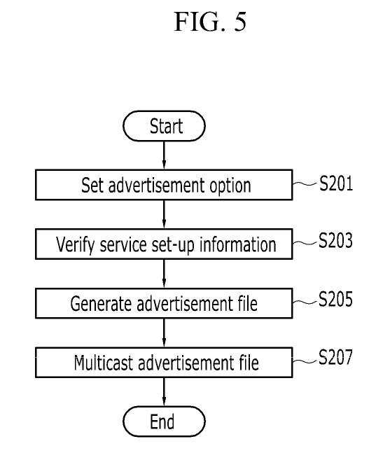

FIG. 5 is a flowchart showing an advertisement file generation method according to an exemplary embodiment of the present invention. Steps of FIG. 5 may be included at any step after step S113 and before step S133 in FIG. 4A.

Referring to FIG. 5, an advertisement generation unit 711 of the service control server 700 establishes the personal broadcasting home shopping service according to a request from the seller terminal 100 and thereafter, sets up an advertisement option (S201).

The advertisement generation unit 711 verifies set-up information of the personal broadcasting home shopping service stored in a service setting DB 703 (S203) and generates an advertisement file on the basis of the verified information (S205).

In this case, an advertisement processing unit 715 multicasts the advertisement file to one or more viewer terminals 200 in a predetermined method (S207). A target to which the advertisement file is multicasted may be a personal broadcasting home shopping service receiving target designated by the seller terminal 100. Alternately, the target may be unspecified individuals in accordance with an operation rule of the service control server 700.

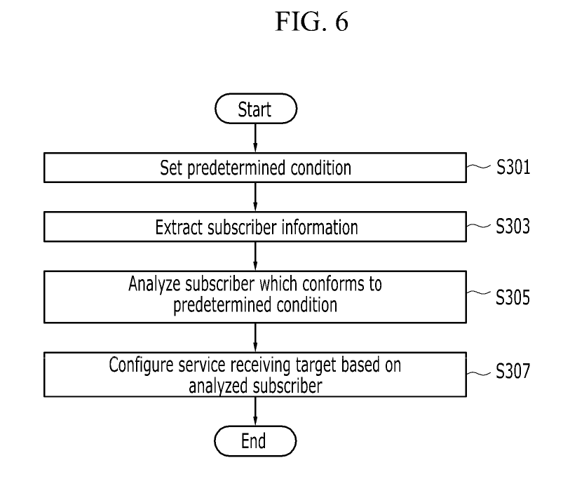

FIG. 6 is a flowchart showing a method for setting information to be received according to an exemplary embodiment of the present invention. The steps of FIG. 5 are performed after step S113 of FIG. 4A.

Referring to FIG. 6, a service setting unit 701 of the service control server 700 sets a predetermined condition for the service receiving target inputted from the seller terminal 100 (S301).

In this case, a user analysis unit 709 of the service control server 700 extracts subscriber information from a subscriber information DB 705 (S303).

The user analysis unit 709 of the service control server 700 analyzes subscribers that conform to the predetermined condition by using the predetermined condition and the extracted subscriber information (S305).

The user analysis unit 709 of the service control server 700 configures the service receiving target on the basis of the subscriber information analyzed at step S305 (S307). That is, the reception target information is configured to multicast the personal broadcasting home shopping service of the seller terminal 100 to the viewer terminal 200 of the subscriber who conforms to the predetermined condition.

According to an embodiment of the present invention, there is provided a real-time home shopping service utilizing a user-centered personal multicasting broadcasting technology by connection of a form of individuals (producer/seller/agent)→a network supporting a broadcast/multicast service (MBMS)→all users or a user group (consumer/producer). Accordingly, customers can actively perform the shopping while interactively exchanging product information through a multimedia broadcasting service in a shopping business utilizing a mobile IPTV and an environment similar as an environment in which the customers deal in products in a real market can be provided.

Further, a shopping procedure can be supported, which enables local purchasing of products and immediate purchasing through real-time connection with a manufacturing spot rather than introducing the products and providing purchasing information for the products only in a shopping center.

In addition, it is possible for a predetermined community or group including a closed user group (CUG) to perform the safe shopping by providing a multicast-type broadcast.

Besides, the present invention proposes an available range of a personal broadcaster, allows a broadcasting provider and a consumer to communicate with each other through a text message and multi-user multimedia communication to form a passage for sharing information on a product and furthermore, directly purchasing the product in a social shopping.

Further, it is highly effective to create and enhance a benefit model by enabling an interactive live shopping, the social shopping, and a personalized shopping for a personalization service. An opportunity to advance to an e-commerce model led by a customer by deviating from an e-commerce service model lead by a supplier is provided from a customer's view.

The above-mentioned exemplary embodiment of the present invention is not implemented only the apparatus and method, but may be implemented by a program that can realize functions corresponding to components of the exemplary embodiment of the present invention or a recording medium in which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing a personal broadcasting home shopping service interworking with a seller terminal capable of photographing a moving picture and at least one viewer terminal capable of receiving a broadcasting signal, which each is provided with a communication function, comprising:
a service control server that establishes a personal broadcasting home shopping service in accordance with a request from the seller terminal and provides an advertisement for the personal broadcasting home shopping service to unspecified ordinary people or a designated user group in order to recruit viewers of the personal broadcasting home shopping service; and
a service center that establishes a broadcast/multicast service session with at least one viewer terminal by receiving information on the personal broadcasting home shopping service of the seller personal from the service control server, receives a real-time moving picture of a product from the seller terminal, and multicasts the received real-time moving picture to the at least viewer terminal through the broadcast/multicast service session.

2. The system of claim 1, further comprising:
a relay server that relays the real-time moving picture traffic by receiving information on the personal broadcasting home shopping service of the seller terminal from the service center, receiving a real-time moving picture traffic of the product from the seller terminal, and transmitting the received real-time moving picture traffic to the at least one viewer terminal under a control of the service center through a mobile communication network.

3. The system of claim 2, wherein:
the relay server includes,
a service interlinking unit that generates service summary information by receiving service set-up information and reception target information, in which the service summary information includes information on a phone number of the seller terminal, and multicasts the service summary information to the at least one viewer terminal included in the reception target information;
a traffic session control unit that controls multicasting of the service summary information and the real-time moving picture by establishing the broadcast/multicast service session with the service center;
a first interface unit that receives the real-time moving picture in a streaming form from the seller terminal through the mobile communication network and sends the received real-time moving picture to the session control unit; and
a second interface unit that transmits the service summary information and the real-time moving picture through the broadcast/multicast service session together established with the service center.

4. The system of claim 3, wherein:
the service set-up information includes product-related text information, and
the traffic session control unit,
establishes a first broadcast/multicast service session for transmitting the real-time moving picture received from the seller terminal and a second broadcast/multicast service session for transmitting the product-related text information and controls the first broadcast/multicast service session and the second broadcast/multicast service session to be linked with each other.

5. The system of claim 1, wherein:
the service control server includes,
a service setting unit that receives and stores the service set-up information and the service receiving target information from the seller terminal in order to establish the personal broadcasting home shopping service, generates product and seller-related information among the service set-up information in a text file form, transmits and stores the product and seller-related information to the relay server in addition the reception target information; and
a service control unit that manages a broadcasting schedule of a personal broadcasting home shopping service for each seller terminal and executing a series of processes related to purchasing determination, and payment and delivery procedures in accordance with requests from the at least one viewer terminal.

6. The system of claim 5, wherein:
the service control server further includes,
a multi-user communication control unit that controls a multi-user communication call by establishing a multi-user communication session between the seller terminal and at least one viewer terminal while the real-time moving picture is multicasted through the session control unit.

7. The system of claim 6, wherein:
the reception target information includes a predetermined condition designated by the seller terminal, in which the predetermined condition is a condition related to a target to which the personal broadcasting home shopping service of the seller terminal is provided, and
the service control server further includes,
a user analysis unit that analyzes subscriber information conforming to the predetermined condition with the previously stored subscriber information and the predetermined condition and selects at least one viewer terminal included in the analyzed subscriber information as a personal broadcasting home shopping service receiving target of the seller terminal.

8. The system of claim 6, wherein:
the service set-up information includes an advertisement option for the personal broadcasting home shopping service established by the seller terminal, and
the service control server further includes,
an advertisement generation unit that generates an advertisement file of a multimedia type on the basis of the service set-up information for the personal broadcasting home shopping service in accordance with the advertisement option information; and
an advertisement reproduction unit that multicasts the advertisement file to at least one viewer terminal included in the reception target information in a predetermined method.

9. A method for providing a personal broadcasting home shopping service by a personal broadcasting home shopping service providing system that interworks with a seller terminal capable of photographing a moving picture and at least one viewer terminal capable of receiving a broadcasting signal, which each is provided with a communication function, comprising:
establishing a personal broadcasting home shopping channel in accordance with a request from the seller terminal and setting reception target information of the personal broadcasting home shopping channel;
receiving a real-time moving picture of a product from the seller terminal through a mobile communication network; and
multicasting the real-time moving picture of the product to at least one viewer terminal through an broadcast/multicast service session established to the at least one viewer terminal included in the reception target information.

10. The method of claim 9, further comprising:
between the setting the reception target information and the receiving the real-time moving picture,
generating service summary information for the personal broadcasting home shopping service, in which the service summary information includes information on a phone number of the seller terminal, and multicasting the service summary information to at least one viewer terminal included in the reception target information.

11. The method of claim 10, further comprising:
after the multicasting,
executing a multi-user communication call by establishing a multi-user communication session between the seller terminal and at least one viewer terminal in accordance with request from one or more viewer terminals.

12. The method of claim 9, wherein:
the multicasting includes,
establishing a first broadcast/multicast service session for transmitting the real-time moving picture received from the seller terminal and a second broadcast/multicast service session for transmitting the product-related text information; and
multicasting the real-time moving picture including the product-related text information to at least one viewer terminal through the first broadcast/multicast service session and the second broadcast/multicast service session that are linked with each other.

13. The method of claim 12, wherein:
the establishing the service session includes,
establishing the personal broadcasting home shopping channel;
receiving a predetermined condition from the seller terminal, in which the predetermined condition is a condition related to a target to which the personal broadcasting home shopping service of the seller terminal is provided; and
analyzing subscriber information which conforms to the predetermined condition by using the previously stored subscriber information and the predetermined condition and including at least one viewer terminal included in the analyzed subscriber information in the reception target information.

14. The method of claim 13, further comprising:
after the including at the establishing the service session,
receiving a request for set-up of advertisement option information for the personal broadcasting home shopping service established by the seller terminal from the seller terminal;
generating an advertisement file of a multimedia type on the basis of the service set-up information for the personal broadcasting home shopping service in accordance with the advertisement option information; and
multicasting the advertisement file to at least one viewer terminal included in the reception target information in a predetermined method.
